(19) United States
(12) Patent Application Publication
(10) Pub. No.: US 2007/0239317 A1
(43) Pub. Date: Oct. 11, 2007

(54) Artificial-Intelligence-Based Energy Auditing, Monitoring and Control

(76) Inventors: Bradley D. Bogolea, Beaver, PA (US); Patrick J. Boyle, Dallas, PA (US); Andrei V. Shindyapin, Boalsburg, PA (US)

Correspondence Address: HELLER EHRMAN LLP, 1717 RHODE ISLAND AVE, NW, WASHINGTON, DC, 20036-3001, US

(21) Appl. No.: 11/696,669

(22) Filed: Apr. 4, 2007

Related U.S. Application Data
(60) Provisional application No. 60/790,361, filed on Apr. 7, 2006.

(51) Int. Cl. G01M 1/38

(52) U.S. Cl. 700/276

(57) ABSTRACT

A method and system are provided for auditing, monitoring and controlling the energy consumption within a utility. Energy consumption data is obtained from a series of modules monitoring and controlling a variety of physical conditions, such as ambient light, temperature, pressure, air velocity, cooling, and heating, and devices. These modules transmit energy consumption and physical conditions data over a wireless personal area network (WPAN) through a transceiver. A central control station obtains the energy consumption data and stores it in an energy usage database. Energy management logic calculates and provides to the user an energy management solution, to reduce energy consumption and costs, by applying rule-based artificial intelligence to the stored energy consumption data in conjunction with information from the Internet. In one embodiment, the energy management solution can automatically control devices to effectively conserve energy.

This application claims priority to U.S. provisional Application No. 60/790,361, filed on Apr. 7, 2006, which is expressly incorporated herein by reference.

### BACKGROUND OF THE INVENTION

1. Field of the Invention

The present invention relates to an approach for providing a user with an energy management solution based on energy consumption data obtained from modules monitoring and controlling energy consumption.

2. Description of the Related Art

Energy efficiency and conservation are becoming an increasingly important issue because the demand for energy is constantly increasing, while the dominant energy supplies—various types of fossil fuels—are steadily dwindling. As a result, energy costs will only grow with time, steadily gaining a larger percentage of both residential and commercial building budgets. In addition, because the majority of energy is produced from fossil fuels, the increased use of this energy source adversely affects the environment, contributing to global warming through the release of carbon oxide gases.

With the increased levels of energy consumption and energy costs, consumers are becoming financially burdened by the cost of energy. For many years, large companies and industrial complexes have used complicated, expensive systems to lower the usage and costs of energy. However, these approaches have proved to be too expensive and complicated for small businesses and residential consumers. As a result, such consumers are left without an effective means of reducing and managing energy usage.

Accordingly, there is a demand for an inexpensive, user-friendly system capable of easy installation that does not require any specialized knowledge. It is desirable that the system advise users of ways to conserve energy in a variety of settings (i.e., building environments/conditions), including home and office. Utilities can also use the system to monitor the efficacy of their energy efficiency programs.

### SUMMARY OF THE INVENTION

The aforementioned needs and others are addressed by the present invention in which a method and system are provided for auditing, monitoring, and controlling energy consumption.

In one aspect of the invention, a method of auditing, monitoring, and controlling energy consumption is disclosed. The method comprises obtaining energy consumption and physical conditions data from a series of modules that monitor and control a variety of physical conditions. These physical conditions are selected from a group consisting of current, voltage, air, velocity, humidity, light, occupancy, pressure, temperature, power, magnetic fields, electric fields, vibration frequency, vibration amplitude, relative location, absolute location, geolocation, altitude, and any combination thereof The method comprises storing the energy consumption and physical conditions data in electronic memory. The method comprises producing an energy management solution using energy management logic. The method comprises providing the user with the energy management solution by applying any of rule-based logic, expert systems programming and combinations thereof to the energy consumption and physical conditions data.

In another aspect of the invention, a system for auditing, monitoring, and controlling the energy consumption is disclosed. The system comprises a series of modules transmitting information over a wireless personal area network (WPAN) to monitor and control energy use and a variety of physical conditions. The physical conditions are selected from a group consisting of current, voltage, air, velocity, humidity, light, occupancy, pressure, temperature, power, magnetic fields, electric fields, vibration frequency, vibration amplitude, relative location, absolute location, geolocation, altitude, and any combination thereof. The system comprises a central control station to receive data transmitted by the modules. The system comprises a storage mechanism to store data transmitted by the modules in electronic memory. The system comprises an energy management logic to monitor and control the energy consumption.

A further understanding of the nature and advantages of the invention will become apparent by reference to the remaining portions of the specification and drawings.

### BRIEF DESCRIPTION OF THE DRAWINGS

FIG. 1 illustrates a system for auditing, monitoring, and controlling energy consumption according to an embodiment of the present invention.

FIG. 2 illustrates a method of energy auditing according to an embodiment of the present invention.

FIG. 3 illustrates a method of monitoring and controlling energy consumption within a utility according to an embodiment of the present invention.

FIG. 4 illustrates a module for monitoring and controlling energy consumption according to an embodiment of the present invention.

### DETAILED DESCRIPTION OF THE PREFERRED EMBODIMENTS

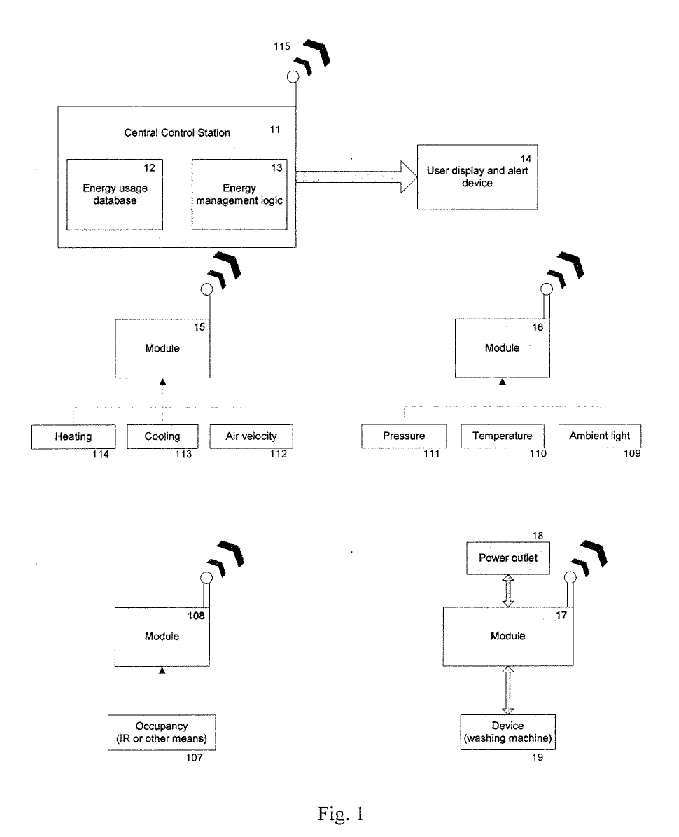

FIG. 1 illustrates a system for auditing, monitoring, and controlling energy consumption according to an embodiment of the present invention. The system comprises of a series of modules 15, 16, 17, and 108 for monitoring and controlling various physical conditions such as cooling 114, heating 113, air velocity 112, temperature 111, pressure 110, ambient light 109, and occupancy 107 and devices 19, such as a washing machine. The system also comprises a central control station 11 for receiving energy consumption data from the modules. The central control station 11 contains an energy usage database 12 for storing the energy consumption data received from the module, and energy management logic 13 for providing a user with an efficient energy management solution via a user display and alert device.

According to FIG. 1, the modules 15, 16, 17, and 108 used for monitoring and controlling energy consumption of a utility are connected to each other as well as the central control station 11 by the means of a wireless personal area network (here after WPAN). The wireless personal area network uses any of a mesh, star, point-to-point, and ad-hoc topology and combinations thereof. Each of the modules 15, 16, 17, and 108 are capable of communicating within a wireless network using the same protocol. According to an embodiment of the present invention, the wireless protocol used for communicating could be an IEEE wireless standard protocol such as IEEE 802.15.4. The modules 15, 16, 17, and 108 use ZigBee specification, in addition to the IEEE wireless standard protocol, to improve and simplify communication over the WPAN. The data communicated is organized according to the requirements of any of the OpenAMI, Itron, OpenWay, Intelligrid, BACnet, LonWorks, or another Automated Metering Intitiative (AMI) standard or building or home automation data or communication standard.

According to FIG. 1, the modules 15, 16, 17, and 108 monitor and /or control different physical conditions such as cooling 114, heating 113, air velocity 112, temperature 111, pressure 110, ambient light 109, and occupancy 107, and devices 19, such as a washing machine. Other conditions comprise electric current, voltage, humidity, pressure, power, magnetic fields, electric fields, vibration frequency, vibration amplitude, relative location, absolute location (geolocation), and altitude. The modules 15, 16, 17, and 108 each comprise at least one sensor for monitoring and at least one relay or switch device for controlling the above physical conditions. The relay or switching device may be implemented in either hardware or software.

According to an embodiment of the present invention, a module can monitor and/or control one or more than one physical condition and/or device. The modules which monitor and control physical conditions 15 and 16, such as cooling 114, heating 113, air velocity 112, temperature 111, pressure 110, ambient light 109, and occupancy 107, further comprise suitable sensors to monitor and control those particular physical conditions. The energy consumption data is stored within the module and transmitted over WPAN to the central control station 11.

In an embodiment of the present invention, the module 17 which monitors and controls the energy consumption and status of a device 19, such as a washing machine, further comprises a clamp to connect an electrical feed wire from the power outlet 18 to the device 19. The module 17 may comprise a plug for connecting the module to the power outlet 18. The module 17 may further comprise a meter for measuring current and voltage intake of the device, an analog to digital converter for converting analog current and voltage data into their digital equivalents, and a processor (not shown) for calculating the energy consumption of the device 19 by multiplying the current and voltage values.

The processor (not shown) in module 17 may further be configured to convert measured AC current and voltage values from AC to RMS. The module 17 may further comprise a memory to store the measured energy consumption of the device, which is then transmitted over the WPAN to the central control station 11.

In one embodiment of the present invention, the memory within the modules 15, 16, 17, and 108 is a volatile memory. In this case the modules 15, 16, 17, and 108 would further comprise a battery or capacitor to maintain the volatile memory. The memory is a non-volatile memory. In another embodiment of the present invention, the power source required to operate the modules may be selected from a group consisting of a battery, capacitor, and a wall outlet. The source of power to operate the modules may be obtained by scavenging energy such as vibration or light from the environment.

The energy consumption data and the device status are transmitted over the WPAN to the central control database 11. According to an embodiment of the present invention, each of the modules 15, 16, 17, and 108, as well as the central control station, may include transceivers 115 to both transmit and receive information over the WPAN. According to another embodiment of the present invention, the central control station 11 may be connected to the WPAN by means of a Personal Computer Memory Card International Association (PCMCIA) hardware network adapter.

The central control station 11 further comprises of an energy usage database 12 and energy management logic 13. The energy consumption data and the device status obtained from the modules 15, 16, 17 and 108 are stored in the energy usage database. The energy usage database 12 may also contain various energy related data such as end use surveys, engineering studies, simulations and device power consumption characteristics as defined by the manufacturer. The energy management logic 13 applies a rule-based artificial intelligence to the obtained energy consumption data stored in the energy usage database 12, in conjunction with historical information, weather predictions, electricity cost information and future cost predictions, to provide a user with an efficient energy management solution.

According to an embodiment of the present invention, the energy management logic 13 may modify the rule-based artificial intelligence to produce a more efficient energy management solution. The energy management solution may further comprise of energy management decisions, on/off schedules and commands to reduce energy consumption and cost. The energy management decisions, on/off schedules and costs are then transmitted over the WPAN to the modules 15, 16, 17, and 108 for execution. The modules 15, 16, 17, and 108 further include a means for cutting off or controlling power supply to appliances and devices and may include electrical devices such as thermostats for controlling energy consumption.

In an embodiment of the present invention, the energy management logic 13 may further instruct a processor to generate logs, reports and/or graphs for the energy consumption data and status of devices. The energy management solution, comprising a recommendation to a user to reduce energy consumption and costs based on historical information obtained and stored from the devices and information from the Internet, is then provided to the user at the user display and alert device 14. According to another embodiment of the present invention, the user display and alert device 14 may be a personal computer, a display console, a mobile phone, an email account or a personal digital assistant (PDA). The user display may also interface with information gateway and demand response technologies from utilities, such as OpenWay, AMR, AMI and OpenAMI. In another embodiment of the invention, the central control station 11 may be a data processing device such as a personal computer or a PDA executing energy management logic 13.

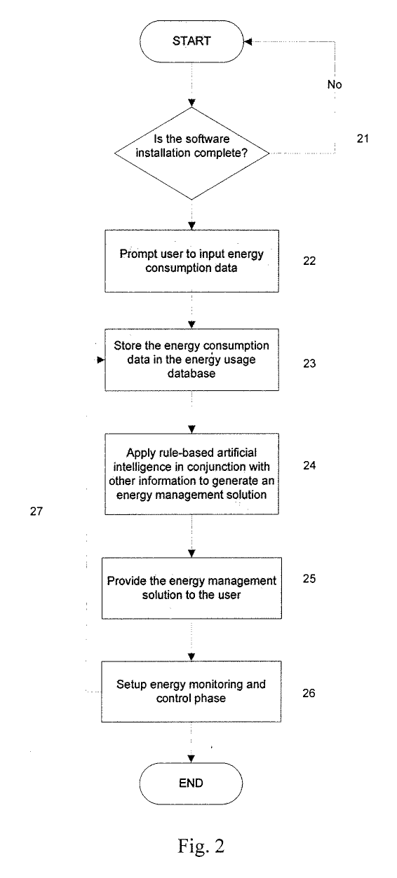

FIG. 2 discloses a method of energy auditing according to an embodiment of the present invention. At the start of this method the user receives executable instructions for auditing, monitoring, and controlling the energy consumption of a utility. The executable instructions may be received by the user embodied either on a computer-readable medium, such as a compact disc, on a signal supplied via a universal serial bus device (USB) or via the Internet. The utility may range from a small private office to a multi story building. The executable instructions may be installed on a data processing device such as a personal computer or a PDA.

At step 21, a check is performed to determine whether the installation of the software comprising the executable instructions is complete and whether energy auditing for the utility may begin. At step 22, a prompt of the user is issued to input the energy consumption data for the utility. The energy consumption data may include previous energy bills, building conditions, environmental conditions, device power usage, and information from sources outside the utilities, such as the utility companion or the internet. The energy consumption data may be directly obtained over a WPAN from monitoring and controlling modules, which are transmitting information over the WPAN. In this case, the data processing device on which the software is running would have to be connected to the WPAN either through the use of a trans-receiver or a Personal Computer Memory Card International Association (PCMCIA) hardware network adapter.

According to an embodiment of the present invention, at step 22, the prompt will inquire from the user six categories of energy use: cooling, heating, lighting, major appliances, water heating and miscellaneous equipment. The prompt may request the user to input energy consumption data for all six categories, or obtain the energy consumption data from monitoring and controlling modules over the WPAN. At step 23, the energy consumption data is stored into an energy usage database. Miscellaneous information may be obtained from the Internet such as future weather predictions. Various data, such as end use surveys, engineering studies, simulations and other industry gathered data may be stored in an internal database.

At step 24, rule-based artificial intelligence and expert systems programming based on industry specific data and knowledge gathered from industry experts are applied to the collected data to generate an energy management solution. Collected data may be from case-studies, utility “pilot” programs to test energy saving advice, and/or services, industry experts or other research sources. The energy management solution may comprise recommendations to the user of various products and services for energy monitoring and management. The recommendations of various products and services may include time-of-use (TOU) pricing options with the user's utility, third-party energy efficient devices and actions to be performed in order to reduce energy costs. Third parties promote products and services for energy monitoring in the form of advertisements, sales, trials, trade-ins and combinations thereof.

At step 25, the energy management solution is provided to the user on the data processing device. An energy monitoring and controlling phase is set up for the user's utility in step 26. Once step 26 has been completed, the method returns to step 23 via 27. The energy monitoring and controlling phase may be completely automated.

For example, the energy management solution may conclude that because there was no movement in an area of a home from 9AM to 5PM, the occupants were at work. Therefore, the air conditioner, lights, and fans were operating unnecessarily. The user would be given the option that, should the house become empty, the air conditioner be adjusted and the lights and fans turned off automatically. Also, if the washing machine was run, the system could run it at the time during which electricity is the least expensive, but before the occupants are expected to get home, so there is a minimum of inconvenience. The system can perform these tasks automatically, or report the potential savings and leave the actions to the user. In either scenario, a cost-savings report can be presented to the user to show how much energy, pollution, money, and other factors were saved or affected by the actions.

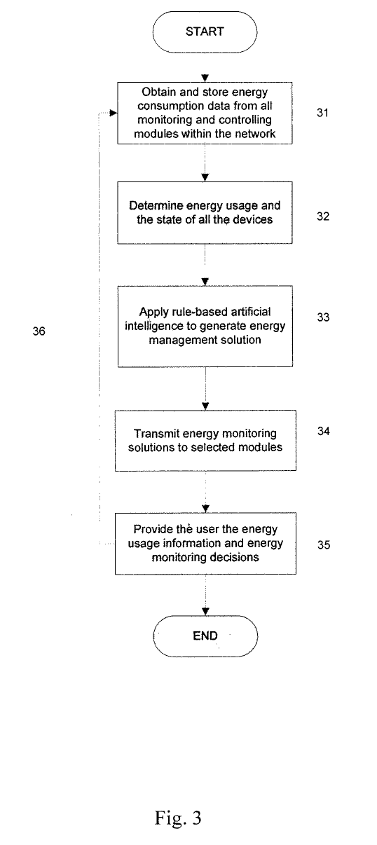

FIG. 3 illustrates a method of monitoring and controlling energy consumption within a utility according to an embodiment of the present invention. At step 31, all the modules monitoring and controlling various physical conditions and devices are instructed to transmit energy consumption data over the WPAN. The modules may be instructed to transmit energy consumption data at regular intervals of time. The time interval after which the modules transmit energy consumption data may be predetermined, specified by the user, or determined by the duration after which sufficient data has been collected and processed to provide an arbitrary number of instructions, commands, events, or recommendations. The energy consumption data is then stored in an energy consumption database.

At step 32, the energy usage of the utility and the operation status of all devices and appliances are determined. The operational status of all the devices and appliances is determined by comparing their operating energy consumption characteristics with their ideal energy consumption characteristics. The ideal energy consumption characteristics are the energy consumption characteristics defined by the manufacturer.

At step 33, a rule-based artificial intelligence is applied to the energy consumption data, in conjunction with weather predictions, electricity cost information and future cost predictions, to produce an energy management solution. Expert systems programming based on industry specific data and knowledge gathered from industry experts is applied to the collected data. The energy management solution may comprise on/off schedules for the appliances and the devices. The energy management solution may also comprise of recommendations for cost savings and lowering energy consumption. Weather predictions, future cost predictions and electricity cost predictions may be downloaded from the Internet and stored in an internal database. The rule-based artificial intelligence may be modified in order to increase efficient usage of energy.

In step 34, the energy monitoring and controlling decisions are transmitted to the respective modules and devices. At step 35, the user is provided with the energy monitoring and controlling decisions. Logs, graphs and/or reports of the energy consumption of the utility may be generated and displayed to the user. The user may also be alerted in case any of the devices or the appliances malfunction. This alert may be sent as a short message service (SMS) to a mobile device, an email message at an email account, a RSS feed, an instant message, an audible alarm, a light indicator, and any combination thereof. Once step 35 has been completed, the method returns to step 31 via 36.

In one embodiment of the present invention, the software may also provide the user with energy management solutions after taking into account the users habits and preferences. This is explained by means of a non-limiting example. If the user switches off all the lights within the utility between 12 AM to 6 AM every day but forgets to switch off the lights on a particular day, the software will notify the user to switch off the lights. The software may also schedule items such as washer, dryer and dishwasher to operate when the energy costs are the cheapest.

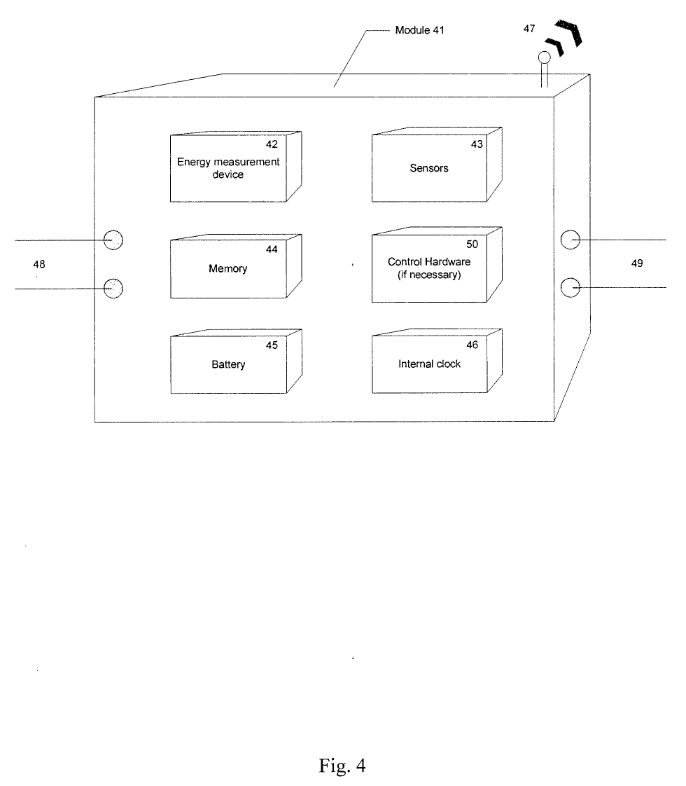

FIG. 4 discloses a module for monitoring and controlling energy consumption according to an embodiment of the present invention. The module 41 may further include an energy measurement device 42, sensor or a plurality of sensors 43, a memory 44, a power source 45, an internal clock 46, control hardware (if necessary) 50, and a processor 51. The module is connected to a WPAN by means of a trans-receiver 47. The communication protocol used by the modules to communicate may be an IEEE wireless standard protocol such as IEEE 802.15.4. The modules may use ZigBee specification in addition to the IEEE wireless protocol to simplify and improve communications.

The module 41 can be used to monitor and or control a variety of physical conditions such as air pressure, water flow, temperature and air velocity. The controlling and monitoring of these conditions is done by sensors 43 within the modules. T

The module 41 may also be able to monitor and/or control devices and appliances such as dishwashers, washing machines and coffee makers. In this case, the module 41 may further include a clamp to connect an electrical feed wire between the power outlet and the device 48. The module 41 may include a plug to connect the module 41 to the power outlet 48, and to connect the module 41 to the device 49. The module 41 may also include an energy measurement device 42. This energy management device may include a means for rectifying alternating current, an analog to digital for converting measured data into digital signals, and a means for calculating the energy consumption of the device.

The module 41 monitors the physical conditions and the devices and stores the measured energy consumption data in a memory 44. The memory used to stored energy consumption data may be a volatile memory. In this case, the module 41 may further comprise a power source 45 to maintain the memory 44, which may be a nonvolatile memory. The power source required to operate the module 41 may be selected from a group consisting of a capacitor, wall unit, battery or energy scavenged from the environment. The energy scavenged from the environment may be in the form of light or vibration.

A transceiver 47 on the module 41 transmits energy consumption data over the WPAN to the central control station 11. Energy management decisions are then received by the module from the central control station via the WPAN. The module 41 may comprise an internal clock to help execute energy management decisions in case central control station 11 malfunctions.

Provided above for the edification of those of ordinary skill in the art, and not as a limitation on the spirit and the scope of the present invention, are detailed illustrations of a method and system for auditing, monitoring, and controlling the energy consumption of a utility via an artificial intelligence-based software and distributed wireless sensor networks. Numerous variations and modifications within the spirit of the present invention will, of course, occur to those of ordinary skill in the art in view of the embodiments that have now been disclosed. For example, while the present invention primarily implements IEEE 802.15.4 wireless standard protocol for communication, the present invention may also effectively implement any standard wireless communication protocol of the IEEE 802 family to establish communication.

As detailed in the illustrative examples contained herein, the present invention implements a WPAN to establish communication. However the present invention may establish communication with data processing devices and modules using TCP/IP protocols.

While the present invention has been described in connection with a number of embodiments, the present invention is not so limited, but is intended to be defined by the scope of the claims which follow and which are to be interpreted as broadly as is reasonable.

What we claim is:

1. A method comprising:
a. obtaining energy consumption and physical conditions data from a series of modules that monitor and control a variety of physical conditions, selected from a group consisting of current, voltage, air velocity, humidity, light, occupancy, pressure, temperature, power, magnetic fields, electric fields, vibration frequency, vibration amplitude, relative location, absolute location, geolocation, altitude, and any combination thereof;
b. storing the energy consumption and physical conditions data in electronic memory;
c. producing an energy management solution using energy management logic to analyze the energy consumption and physical conditions data; and
d. providing a user with the energy management solution by applying any of a rule-based logic, expert systems programming and combinations thereof to the energy consumption and physical conditions data.

2. The method of claim 1, wherein the modules communicate over a wireless personal area network (WPAN).

3. The method of claim 2, wherein the wireless personal area network used by the modules to communicate uses a topology selected from a group consisting of any of a mesh, star, point-to-point, ad-hoc topology and combinations thereof.

4. The method of claim 1, wherein the modules operate within any wireless network which uses the same communication protocol.

5. The method of claim 4, wherein the communication protocol is an IEEE 802.15.4 wireless standard protocol.

6. The method of claim 5, wherein the modules further use a specification for communication.

7. The method of claim 6, wherein the energy consumption and physical conditions data communicated is organized according to the requirements of a standard selected from the group consisting of OpenAMI, Itron, OpenWay, Intelligrid, BACnet, LonWorks, another Automated Metering Initiative (AMI) standard and a building or home automation data or communications standard.

8. The method of claim 1, wherein the specification used by the modules for communication is a ZigBee specification.

9. The method of claim 8, wherein the data communicated is organized according to the requirements of a standard selected from the group consisting of OpenAMI, Itron, OpenWay, Intelligrid, BACnet, LonWorks, another Automated Metering Initiative (AMI) standard and a building or home automation data or communications standard.

10. The method of claim 1, wherein the modules contain at least one sensor for monitoring and relay or switching device for controlling the physical conditions.

11. The method of claim 10, wherein the relay or switching device may be implemented in hardware or software.

12. The method of claim 1, wherein the modules further comprise a memory to store the energy consumption and physical conditions data.

13. The method of claim 10, wherein the memory to store the energy consumption and physical conditions data is a volatile memory.

14. The method of claim 12, wherein the memory to store the energy consumption data is a nonvolatile memory.

15. The method of claim 1, wherein the modules receive operating power selected from a group consisting of a battery, capacitor, wall outlet, scavenged energy from the surrounding environment, and combinations thereof.

16. The method of claim 1, wherein the modules are configured to be clamped onto an electrical feed wire.

17. The method of claim 1, wherein the modules are configured to be plugged into a pre-existing wall outlet.

18. The method of claim 1, wherein the modules further comprise infra red, capacitive coupling, pyroelectric infra red, carbon-dioxide, or ultrasonic occupancy sensors.

19. The method of claim 1, wherein the information used in the implementation of expert systems programming is industry specific data and knowledge gathered from any of case studies, utility “pilot” programs to test energy saving advice, devices, services, industry experts, and other research sources.

20. The method of claim 1, wherein providing a user with an energy management solution is selected from a group consisting of an SMS, an email alert, an RSS feed, instant messaging platform, an audible alarm, a light indicator and combinations thereof.

21. The method of claim 1, wherein the energy management solution may be provided in one of several methods, comprising:
a. a single report-style solution provided to the user after data measurement and processing has taken place;
b. a periodic report-style solution provided to the user after a predetermined interval of time; or
c. a continuous, real-time report provided to the user as soon as sufficient data has been collected and processed to provide an arbitrary number of instructions, commands, events or recommendations.

22. A system comprising:
a. a series of modules transmitting energy consumption and physical conditions data over a wireless personal area network (WPAN) to monitor and control energy use and a variety of physical conditions, selected from a group consisting of current, voltage, air velocity, humidity, light, occupancy, pressure, temperature, power, magnetic fields, electric fields, vibration frequency, vibration amplitude, relative location, absolute location, geolocation, or altitude, and any combination thereof;
b. a central control station to receive the energy consumption and physical conditions data transmitted by the modules;
c. a storage mechanism to store the energy consumption and physical conditions data transmitted by the modules in electronic memory; and
d. an energy management logic to monitor and control the energy consumption.

23. The system of claim 22, wherein the personal area network used by the modules to communicate uses topology selected from a group consisting of a mesh, star, point-to-point, or ad-hoc topology, and combinations thereof.

24. The system of claim 22, wherein the modules have the ability to work within any wireless network using the same communication protocol or standard.

25. The system of claim 22, wherein the communication protocol is an EEE 802.15.4 wireless standard protocol.

26. The system of claim 25, wherein the energy consumption and physical conditions data communicated is organized according to the requirements of a standard selected from the group consisting of OpenAMI, Itron, OpenWay, Intelligrid, BACnet, LonWorks, another Automated Metering Initiative (AMI) standard, and a building or home automation data or communications standard.

27. The system of claim 22, wherein the specification used by the modules for communication is the ZigBee specification.

28. The system of claim 27, wherein the energy consumption and physical conditions data communicated is organized according to the requirements of a standard selected from the group consisting of OpenAMI, Itron, OpenWay, Intelligrid, BACnet, LonWorks, another Automated Metering Initiative (AMI) standard, and a building or home automation data or communications standard.

29. The system of claim 22, wherein the modules further comprise:
a. means for converting analog signals to digital signals;
b. means for calculating the power consumption of a device;
c. means for controlling the flow of electricity to a device;
d. means for measuring current and voltage data; and
e. means for converting AC current and voltage data to corresponding RMS values.

30. The system of claim 22, wherein the central control station is a data processing device.

31. The system of claim 30, wherein the data processing device is selected from a group consisting of a personal computer, personal digital assistant, embedded computer and combinations thereof.

32. The system of claim 22, wherein the energy management logic comprises executable instructions on a computer-readable medium processed in the central control station.

33. The system of claim 22, wherein communication between the central control station and the wireless personal area network is selected from a group consisting of a USB, IEEE1394 interface, PCMCIA hardware network adapter, and combinations thereof.

34. The system of claim 22, wherein the energy management logic further comprises:
a. instructions for obtaining energy consumption and physical conditions data from the series of modules;
b. instructions for obtaining additional information from the Internet;
c. instructions for comparing the energy consumption of a device with ideal operating condition of the device;
d. instructions for generating energy consumption logs and device status reports;
e. rule-based artificial intelligence to monitor and control energy consumption;
f. instructions for providing a user with the energy consumption logs and status reports; and
g. instructions for providing third parties with the ability to promote products and services.

35. The system of claim 34 wherein promotions of products and services may be in the form the group of advertisements, sales, trials, trade-ins, and combinations thereof.
